(19) United States
(12) Patent Application Publication
(10) Pub. No.: US 2019/0064789 A1
(43) Pub. Date: Feb. 28, 2019

(54) SYSTEM ANALYZING DEVICE, SYSTEM ANALYZING METHOD, AND COMPUTER-READABLE RECORDING MEDIUM

(71) Applicant: NEC CORPORATION, Tokyo (JP)

(72) Inventor: Masanao NATSUMEDA, Tokyo (JP)

(73) Assignee: NEC CORPORATION, Tokyo (JP)

(21) Appl. No.: 16/080,514

(22) PCT Filed: Feb. 21, 2017
(86) PCT No.: PCT/JP2017/006440

§ 371 Date: Aug. 28, 2018

(30) Foreign Application Priority Data
Feb. 29, 2016 (JP) 2016-038078

(51) Int. Cl. G05B 23/02; G01D 9/00

(52) U.S. Cl. CPC G05B 23/0281; G05B 23/024; G01D 9/005; G05B 23/0221; G05B 23/0254

(57) ABSTRACT

A system analyzing device (100) includes a history information generation unit (14) that generates history information for each of multiple sensors (21) included in a subject system (200) based on sensor values output by the sensors (21), and an output unit (16) that presents, to a user, cluster information obtained by clustering the sensors (21) into one or more groups based on the generated history information.

### TECHNICAL FIELD

The present invention relates to a system analyzing device and a system analyzing method for analyzing the state of a system, and also to a computer-readable recording medium having recorded thereon a program for realizing the device and method.

### BACKGROUND ART

Recent years have seen the use of system analyzing devices that analyze the state of a system based on sensor data obtained from constituent elements of the system. Analysis processing performed such a system analyzing device is performed for the purpose of operating the system safely and efficiently. Also, this analysis processing includes processing for detecting an abnormality in the system by performing multivariate analysis on the sensor data. In this analysis processing, upon detecting an abnormality in the system, the system analyzing device notifies an operator and the system of the abnormality. As a result, the abnormality or a sign of the abnormality is detected at an early stage and a countermeasure initial response can be performed earlier, thus making it possible to minimize the damage.

Examples of systems that are subjected to this analysis processing include a collective or a mechanism constituted by elements that can influence each other, such as an ICT (Information and Communication Technology) system, a chemical plant, a power station, and a power plant.

Incidentally, in some system analyzing devices, upon detecting an abnormality in the system, the system analyzing device provides information that contributes to specification of the cause. One example of the provided information is a sensor name that is related to the abnormality. Patent Documents 1 and 2 disclose technology for notifying an operator and a system of such a sensor name related to an abnormality.

Specifically, Patent Document 1 discloses a process monitoring and diagnosing device. The process monitoring and diagnosing device disclosed in Patent Document 1 provides, as the sensor name related to the abnormality, the name of the sensor that had a high abnormality level at the time when the system analyzing device detected the abnormality.

Also, Patent Document 2 discloses a time series data processing device. With the time series data processing device disclosed in Patent Document 2, an abnormality propagation order is estimated based on time series data in a certain period, and sensor names related to the abnormality are reordered in the estimated abnormality propagation order when being provided.

### LIST OF PRIOR ART DOCUMENTS

### Patent Document

Patent Document 1: JP 2014-96050A

Patent Document 2: JP 2014-115714A

### DISCLOSURE OF THE INVENTION

### Problems to be Solved by the Invention

However, with the devices disclosed in aforementioned Patent Documents 1 and 2, if multiple events that include various types of abnormalities or signs of abnormalities are detected, the detected events are output in a mixed manner. For this reason, the devices disclosed in Patent Documents 1 and 2 have a problem in that the operator and the system cannot properly understand the situation.

One example of an object of the present invention is to resolve the aforementioned problem and provide a system analyzing device, a system analyzing method, and a computer-readable recording medium that, if multiple events occur in a system subjected to analysis, can separate the events and output information that corresponds to respective events.

### Means for Solving Tie Problems

In order to achieve the aforementioned object, a system analyzing device according to an aspect of the present invention includes:

a history information generation unit that generates history information for each of a plurality of sensors included in a subject system based on sensor values output by the sensors; and

an output unit that presents, to a user, cluster information obtained by clustering the plurality of sensors into one or more groups based on the generated history information.

Also, in order to achieve the aforementioned object, a system analyzing method according to an aspect of the present invention includes:

(a) a step of generating history information for each of a plurality of sensors included in a subject system based on sensor values output by the sensors; and

(b) a step of presenting, to a user, cluster information obtained by clustering the plurality of sensors into one or more groups based on the generated history information.

Furthermore, in order to achieve the aforementioned object, a computer-readable recording medium according to an aspect of the present invention has recorded thereon a program that includes instructions for causing a computer to execute:

(a) a step of generating history information for each of a plurality of sensors included in a subject system based on sensor values output by the sensors; and

(b) a step of presenting, to a user, cluster information obtained by clustering the plurality of sensors into one or more groups based on the generated history information.

### Advantageous Effects of the Invention

As described above, according to the present invention, if multiple events occur in a system subjected to analysis, it is possible to separate the events and output information that corresponds to respective events.

### BRIEF DESCRIPTION OF THE DRAWINGS

FIG. 1 is a block diagram showing a schematic configuration of a system analyzing device according to a first embodiment of the present invention.

FIG. 2 is a block diagram showing a specific configuration of the system analyzing device according to the first embodiment of the present invention.

FIG. 3 is a diagram showing an example of output results obtained by the system analyzing device according to the first embodiment of the present invention.

FIG. 4 is a diagram showing an example of output results obtained by the system analyzing device according to the first embodiment of the present invention.

FIG. 5 is a diagram showing an example of output results obtained by the system analyzing device according to the first embodiment of the present invention.

FIG. 6 is a flowchart of operations of the system analyzing device according to the first embodiment of the present invention.

FIG. 7 is a block diagram showing a specific configuration of a system analyzing device according to a second embodiment of the present invention.

FIG. 8 is a flowchart of operations of the system analyzing device according to the second embodiment of the present invention.

FIG. 9 is a block diagram showing an example of a computer that realizes a system analyzing device according to the first or second embodiment of the present invention.

### MODES FOR CARRYING OUT THE INVENTION

### First Embodiment

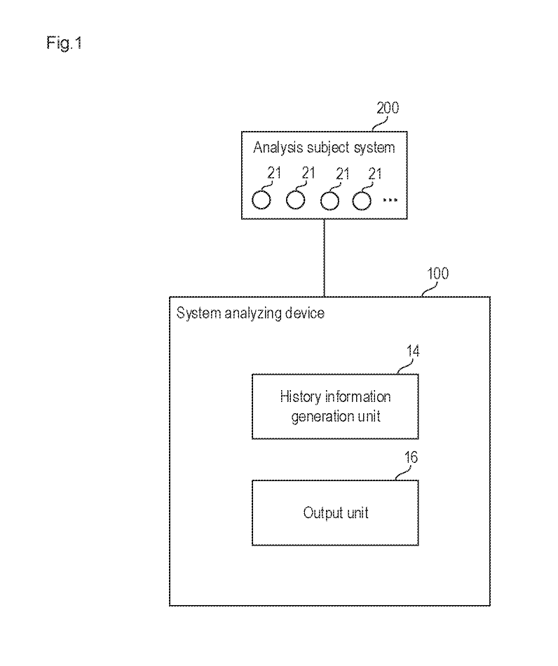

Hereinafter, a system analyzing device, a system analyzing method, and a program according to a first embodiment of the present invention will be described with reference to FIGS. 1 to 3.

Device Configuration

First, the schematic configuration of the system analyzing device according to the first embodiment of the present invention will be described with reference to FIG. 1. FIG. 1 is a block diagram showing the schematic configuration of the system analyzing device according to the first embodiment of the present invention.

As shown in FIG. 1, a system analyzing device 100 of the first embodiment is a device for performing analysis on a subject system (hereinafter, called an “analysis subject system”) 200, and includes a history information generation unit 14 and an output unit 16.

The history information generation unit 14 generates history information for each of multiple sensors 21 provided in the analysis subject system 200, based on the results of processing sensor values output by the sensors 21. The number of sensors 21 provided in the analysis subject system 200 is not limited to four. The output unit 16 presents, to a user, cluster information obtained by clustering the sensors 21 into one or more groups based on the generated history information.

The sensor values output by the sensors are various types of values obtained from constituent elements of the analysis subject system 200. One example of a sensor value is a measurement value acquired through a sensor provided in a constituent element of the analysis subject system 200. Examples of such a measurement value include a valve opening, a liquid level height, a temperature, a flow rate, a pressure, a current, and a voltage. An estimated value calculated based on such a measurement value is also an example of a sensor value. Yet another example of a sensor value is a control signal emitted by an information processing device for changing the analysis subject system 200 to a desired operation state.

As described above, in the present embodiment, groups of sensors 21 obtained from history information that is based on sensor value processing results are presented to the user. At this time, the sensors 21 are divided into groups by event. For this reason, according to the present embodiment, if multiple events occur in the analysis subject system 200, it is possible to separate the events and output information that corresponds to respective events.

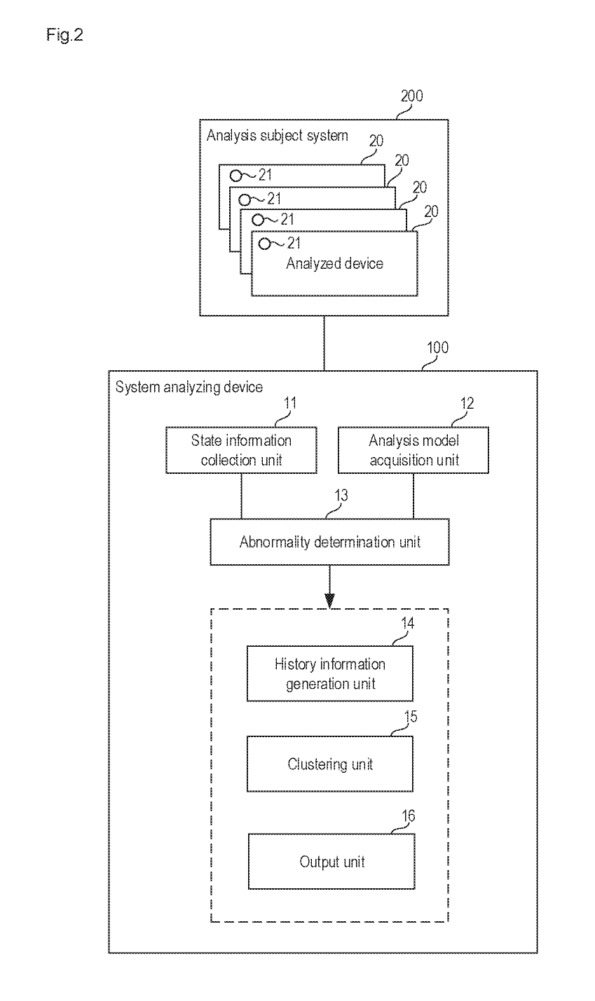

Next, the configuration of the system analyzing device of the first embodiment will be described in more detail with reference to FIG. 2. FIG. 2 is a block diagram showing the specific configuration of the system analyzing device according to the first embodiment of the present invention.

As shown in FIG. 2, in the first embodiment, the system analyzing device 100 includes a state information collection unit 11, an analysis model acquisition unit 12, an abnormality determination unit 13, and a clustering unit 15, in addition to the history information generation unit 14 and the output unit 16 that are described above. These units will be described later.

Also, as shown in FIG. 2, the system analyzing device 100 is connected to the analysis subject system 200 via a network. The system analyzing device 100 is a device that analyzes an abnormality that has occurred in the analysis subject system 200 based on sensor values from the analysis subject system 200, and outputs analysis results and additional information. Note that in FIG. 2, the dashed-line rectangle surrounding the history information generation unit 14, the clustering unit 15, and the output unit 16 indicates that the surrounded function blocks are operating based on information output by the abnormality determination unit 13.

Also, in the first embodiment, the analysis subject system 200 includes one or more devices 20, and these devices 20 are the subjects of analysis. In the following, the devices 20 will be called “analyzed devices” 20. As one example, the analysis subject system 200 is a power generating plant system. In this case, the analyzed devices 20 are a turbine, a feed water heater, a condenser, and the like. Also, the analyzed device 20 may include elements that connect devices to each other, such as pipes and signal lines. Furthermore, the analysis subject system 200 may be a whole system such as the above-described power generating plant system, or may be a portion that realizes part of the functions of the system. Other examples include a collective or a mechanism constituted by elements that can influence each other, such as an ICT (Information and Communication Technology) system, a chemical plant, a power generating station, and a power plant.

In each of the analyzed devices 20, the sensors 21 included in the analyzed device 20 measure sensor values at predetermined timings, and transmit the measured sensor values to the system analyzing device 100. Also, the “sensor” 21 in the first embodiment includes not only a physical hardware object such as a normal measurement device, but also software and a control signal output source for example, and these elements will be collectively referred to as “sensors”. The sensor values are values obtained from sensors. Examples of the sensor values include measurement values measured by measurement devices installed in a facility, such as a valve opening, a liquid level height, a temperature, a flow rate, a pressure, a current, and a voltage. Other examples of the sensor values include an estimated value calculated from a measurement value, and the value of a control signal. Hereinafter, the sensor values are expressed by numerical values such as integers and decimals. Note that although one sensor 21 is provided in each analyzed device 20 in FIG. 2, there are no particular limitations on the number of sensors 21 provided in each analyzed device 20.

Also, in the first embodiment, one data item is assigned for each of the sensors 21 corresponding to the sensor values obtained from the analyzed devices 20. Also, a set of sensor values from the analysis devices 20 deemed to have been collected at the same timing will be called “state information”. Furthermore, a set of data items corresponding to the sensor values included in such state information will be called a “data item group”.

In other words, in the first embodiment, the state information is constituted by multiple data items. Here, “deemed to have been collected at the same timing” may refer to having been measured by the analyzed devices 20 at the same time or at times within a predetermined range. Also, “deemed to have been collected at the same timing” may refer to having been collected by the system analyzing device 100 in one series of collection processing.

Also, in the first embodiment, a storage device (not shown in FIG. 2) that stores the sensor values acquired by the analyzed device 20 may be provided between the analyzed device 20 and the system analyzing device 100. Examples of the storage device include a data server, a DCS (Distributed Control System), a SCADA (Supervisory Control And Data Acquisition), and a process computer. In the case of such an aspect, the analyzed devices 20 acquire sensor values at arbitrary timings and store the acquired sensor values in the storage device. The system analyzing device 100 reads out the sensor values stored in the storage device at a predetermined timing.

The following describes details of the function blocks of the system analyzing device 100. First, the state information collection unit 11 collects state information from the analysis subject system 200. The analysis model acquisition unit 12 acquires an analysis model for analyzing the analysis subject system 200.

The analysis model is a model used when determining whether the sensors are normal or abnormal according to the sensor values from the sensors 21, or calculating an abnormality level indicating how abnormal the sensors are, and is constructed based on part or all of the data items that constitutes the state information of the analysis subject system 200. The analysis model is a model used when making the normal/abnormal determination or performing abnormality level calculation for each sensor 21 when state information collected by the state information collection unit 11 has been input.

Also, the analysis model may be a set of models. If the analysis model is a set of models, the results of the normal/abnormal determination performed for each sensor may be redundant. Furthermore, the redundant normal/abnormal determination results for each sensor in the analysis model are not required to be uniform. The analysis model may be constructed based on a time series of state information obtained for the analysis subject system 200.

Furthermore, in the first embodiment, the analysis model may be stored in a storage device (not shown in FIG. 2) of the system analyzing device 100, or may be input from an external device. In the former case, the analysis model acquisition unit 12 acquires the analysis model from the storage device. On the other hand, in the latter case, the analysis model acquisition unit 12 acquires the analysis model from an external device via a network, a recording medium, or an input device such as a keyboard, for example.

The abnormality determination unit 13 performs determination or calculation for each sensor by applying the analysis model acquired by the analysis model acquisition unit 12 to the state information collected by the state information collection unit 11, and outputs the results of the determination or calculation.

In the first embodiment, the history information generation unit 14 generates the history information based on the results output by the abnormality determination unit 13 in a predetermnnined period. The history information includes time series data regarding the abnormal or normal state of all of the sensors included in the analysis model in the predetermined period. Specifically, the history information includes the identifiers of data items of sensors, and determination results regarding the normal or abnormal state acquired according to the time series for each of the data items (time series data).

Also, the history information includes one or more of the following types of time series data (1) to (3), for example.

(1) Time series data indicating normal/abnormal determination results. For example, this data includes data holding information indicating a normal or abnormal state that is a normal/abnormal determination result for each time when determination data was obtained, or for each time when state information to which determination data belongs was obtained. Also, if multiple normal/abnormal determination results are obtained for one sensor for example, the determination results may be subjected to statistical processing in order to generate time series data indicating a normal/abnormal determination result for one sensor. As one example of such processing, the normal/abnormal determination results of sensors are calculated based on the graph pattern obtained by adding the normal/abnormal determination results of the relationship between the sensors as information, to a graph structure having points indicating the sensors and lines indicating the relationship between the sensors (e.g., a later-described correlation model). The calculation of this processing may be applied to determination results at one time, or may be applied to determination results corresponding to a specific period.

(2) Time series data indicating feature amounts generated from normal/abnormal determination results. For example, the time series data indicating feature amounts includes information regarding the length of a period in which a normal or abnormal state occurred continuously. Also, the time series data indicating feature amounts may include the number of times that a normal or abnormal state occurred consecutively or nonconsecutively in a predetermined period. Furthermore, the time series data indicating feature amounts may include information regarding a sum total of periods in which a normal or abnormal state occurred, for example.

(3) Time series data indicating abnormality levels that indicate the extent to which a sensor value is abnormal. The time series data indicating sensor abnormality levels includes values estimating the extent to which a sensor is abnormal. Also, the time series data indicating sensor abnormality levels may include information regarding the deviation between a prediction of and a measurement of a sensor value at a predetermined time (the difference between the prediction and the measurement, or the percentage of error between the prediction and the measurement). Furthermore, the time series data indicating sensor abnormality levels may include a degree of contribution to a T² statistical amount or a Q statistical amount in multivariate statistical process management, for example.

Also, in the first embodiment, the history information generation unit 14 may acquire the information necessary for generating the history information not only from the above-described abnormality determination unit 13, but also from the analysis model acquisition unit 12.

The clustering unit 15 clusters the sensors 21 into one or more groups based on the generated history information. The clustering unit 15 clusters the sensors included in the analysis model into one or more groups based on, for example, the time series data in the above-described predetermined period included in the history information.

Specifically, the clustering unit 15 can cluster the sensors with use of a clustering algorithm used in data mining, such as k-means, x-means, NMF, Convolutive-NMF, affinity propagation, or the like.

Also, the time series data in the above-described predetermined period included in the history information is assumed to be data in which a one-dimensional feature amount (scalar value, i.e., abnormality continuation time, for example) is defined at each time. In this case, the clustering unit 15 can also use a change-point detection or time-series segmentation algorithm used in data mining in addition to the above-described clustering algorithm used in data mining. Note that the feature amounts included in the history information are not limited to being one-dimensional in other examples.

Also, the clustering unit 15 may successively use clustering results and execute clustering multiple times.

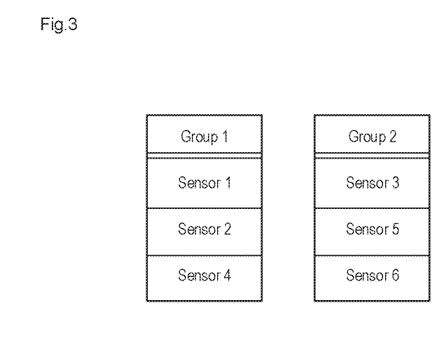

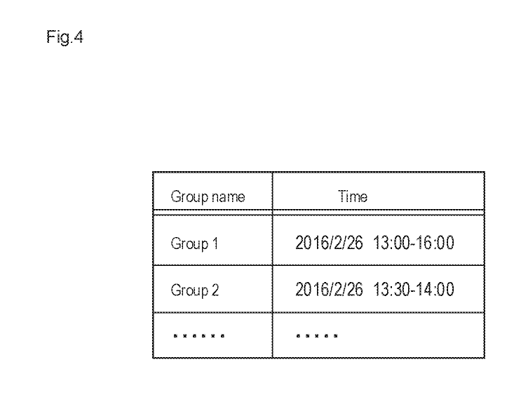

As shown in FIG. 3 for example, the output unit 16 presents the groups of sensors obtained by the clustering performed by the clustering unit 15 to the user such as the operator or the system. Also, as shown in FIG. 4 for example, the output unit 16 may furthermore output the results of estimating a range of time during which an abnormality was suspected to occur for each group of sensors. Additionally, the output unit 16 may reorder the groups of sensors according to the sequence relationship between the suspected abnormality occurrence times, and output the results in the reordered sequence. FIGS. 3 and 4 are diagrams showing examples of output results obtained by the system analyzing device according to the first embodiment of the present invention.

Furthermore, in the first embodiment, in addition to the sensor groups, the output unit 16 may output the abnormality levels at a predetermined time, a statistical value thereof, or re-calculated values for the sensors that belong to a sensor group of interest. Note that there are no particular limitations on the method by which the output unit 16 presents the sensor groups.

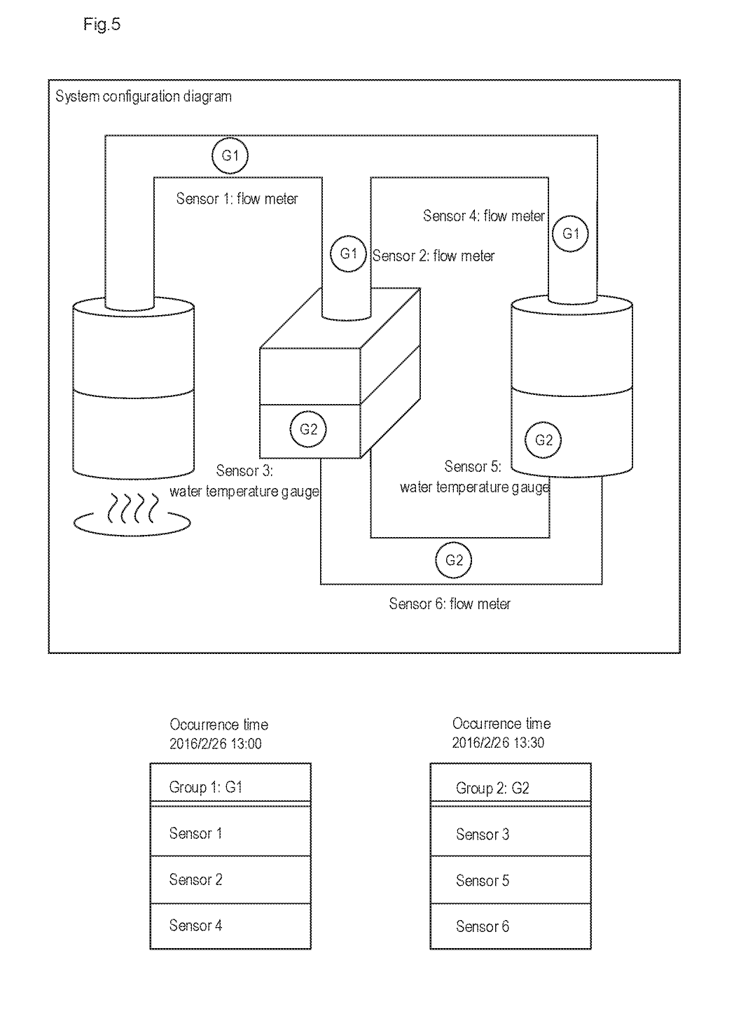

Also, the output unit 16 may present the groups of sensors 21 using a list of sensor names, or using a system configuration diagram with markers having the same number for each cluster as shown in FIG. 5. In the latter case, that is to say in the case of presenting the groups of sensors using a system configuration diagram with markers having the same number for each cluster, the output unit 16 preferably outputs the cluster numbers in the order of suspected abnormality occurrence time. FIG. 5 is also a diagram showing an example of output results obtained by the system analyzing device according to the first embodiment of the present invention. Note that the analysis subject system shown in FIG. 5 is a power generating plant system. Also, in FIG. 5, G1 and G2 are cluster numbers given to groups.

Furthermore, the output unit 16 can also present the percentages of types of physical values of sensors included in the sensor groups, and the percentages of sensors systems included in the sensor groups, in the form of a PI chart or a list. Note that the term “sensor system” indicates a configuration unit of a functional system. The “sensor systems” are designated by the operator in advance.

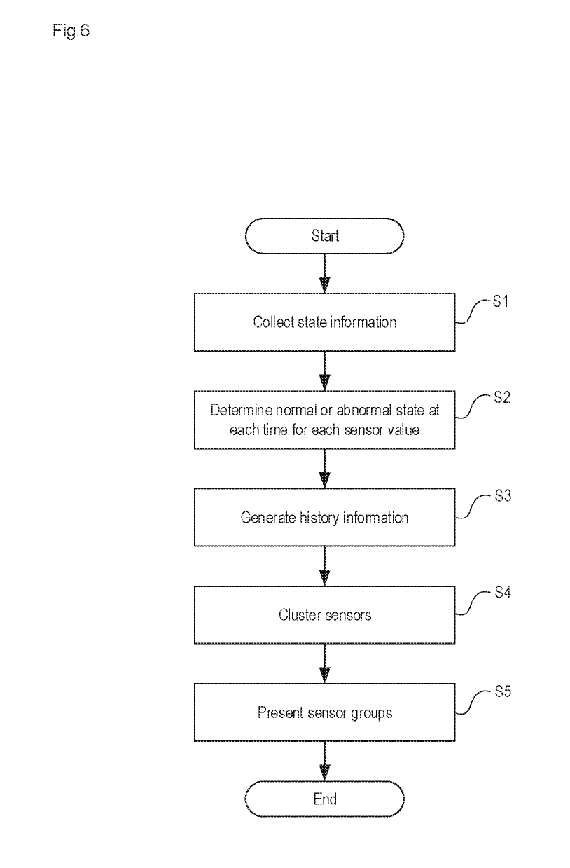

Device operation Next, operations of the system analyzing device 100 in the first embodiment of the present invention will be described with reference to FIG. 6. FIG. 6 is a flowchart of operations of the system analyzing device 100 according to the first embodiment of the present invention. FIGS. 1 and 2 will be referenced as necessary in the following description. Also, in the first embodiment, a system analyzing method is implemented by causing the system analyzing device 100 to operate. Accordingly, the following description of operations of the system analyzing device 100 will substitute for a description of the system analyzing method in the first embodiment.

First, it is assumed that the analysis model acquisition unit 12 has acquired an analysis model in advance. As shown in FIG. 6, first, the state information collection unit 11 collects state information in a predetermined period from the analysis subject system 200 (step S1).

Next, the abnormality determination unit 13 makes a determination regarding the sensor values included in the state information for each time with use of the analysis model that has been acquired in advance by the analysis model acquisition unit 12 (step S2). In one example, it is determined whether a sensor value belongs to either normal or abnormal for each time. In another example, a determination regarding the abnormality level of a sensor value is made for each time.

Next, the history information generation unit 14 generates history information based on the sensor value determination results obtained by the abnormality determination unit 13 (step S3). Specifically, in step S3, the history information generation unit 14 acquires a normal or abnormal determination result for each sensor obtained by the abnormality determination unit 13, and uses the determination results acquired along a time series (i.e., time series data) as the history information (step S3).

Next, based on the history information generated in step S3, the clustering unit 15 clusters the sensors included in the analysis model into one or more groups (step S4). Specifically, the clustering unit 15 clusters the sensors with use of a known clustering technique, based on the time series data that is included in the history information and is regarding the normal state or abnormal state for each sensor in the predetermined period.

Next, the output unit 16 presents the sensor groups obtained by the clustering in step S4 to the user such as the operator or the system (step S5). The above-described processing in the system analyzing device 100 thus ends. Also, steps S1 to S5 are executed again when state information is output from the analysis subject system 200 after a predetermined period has elapsed.

### Effects of First Embodiment

As described above, in the first embodiment, even if multiple events are included, the system analyzing device 100 can separate the events by performing clustering. For this reason, with the system analyzing device 100, it is possible to output information for respective events.

In other words, in the first embodiment, sensors are clustered based on time series data regarding the abnormal or normal state of all of the sensors included in the analysis model, and therefore the sensors are clustered for each change in the time series regarding the abnormal or normal state. Accordingly, even if different types of abnormalities occur in succession, and the different types of abnormalities occur at different times, the sensors are grouped according to the respective types of abnormalities. As a result, the user can obtain information for the respective types of abnormalities.

Next, variations of the first embodiment will be described below. Note that the following description focuses on differences from the example described above.

First Variation

In a first variation, for each sensor, the history information generation unit 14 specifies the length of time for which it was determined that the sensor was abnormal, and the specified lengths of time are used as the history information. In the first variation, the history information includes identifiers of data items of sensors and the lengths of times for which it was determined that the sensors were abnormal. Also, in the case of the lengths of time for which it was determined that the sensors were abnormal, it is possible to obtain the percentage of times that it was determined that an individual sensor was abnormal in the predetermined period, and then specify the length of time of by multiplying the obtained percentage by the predetermined period. In another method, the length of time may be specified by obtaining the total period for which it was determined that an individual sensor was abnormal in the predetermined period. As yet another method, the length of time may be specified by obtaining the total number of times that it was determined that an individual sensor was abnormal or the total number of times that an individual sensor transitioned from normal to abnormal in the predetermined period.

In this way, the lengths of times for which it was determined that the sensors are abnormal are also time series data regarding the abnormal or normal state, and therefore even when applying the first variation, effects similar to the effects of the first embodiment described above are obtained. Furthermore, the lengths of time for which it was determined that the sensors were abnormal are one-dimensional data, and therefore in the first variation, the clustering unit 15 can execute clustering calculation with use of a low amount of calculation resources.

Second Variation

In a second variation, for each sensor, the history information generation unit 14 specifies the length of time for which it was consecutively determined that the sensor was abnormal, and the specified lengths of time are used as the history information. In the second variation, the history information includes the identifiers of data items of sensors, and the length of time for which it was consecutively determined that a sensor was abnormal using the most recent time in the predetermined period as the end time (hereinafter, called the “consecutive abnormal time”).

Also, the history information generation unit 14 can calculate the consecutive abnormal time using statistical processing. This is for the case where the sensor data fluctuates due to sensor noise or disturbance, or the case where the abnormality level is low and the normal/abnormal determination fluctuates between normal and abnormal.

Specifically, first, the history information generation unit 14 divides the predetermined period into multiple periods, and for each divided period, determines whether or not the percentage of time of abnormal determination results is greater than a predetermined threshold value. The history information generation unit 14 then specifies a group of divided periods having consecutive abnormal determination results using the most recent time in the predetermined period as the end point, and uses the length of the specified group of divided periods as the length of the consecutive abnormal time. Note that the overlapping of normal or abnormal determination results for each sensor in the predetermined period may be permitted or prohibited.

Also, the predetermined threshold value used in the determination in divided periods may be set by the user giving a desired numerical value, or may be set based on a confidence interval in a Poisson distribution in the length of the divided periods when it is supposed that the normal/abnormal fluctuations are random.

Alternatively, more simply, in the case where a normal determination result is temporarily obtained in a period shorter than a predetermined length and then returns to an abnormal determination result again, it is possible to ignore the period of the normal determination result (consider it to be an abnormal determination result). Even with this method, there are cases where it is possible to calculate an effective consecutive abnormal time.

In this way, the consecutive abnormal times are also time series data regarding the abnormal or normal state, and therefore even when applying the second variation, effects similar to the effects of the first embodiment described above are obtained. Furthermore, the consecutive abnormal times are one-dimensional data, and therefore in the second variation, the clustering unit 15 can execute clustering calculation with use of a low amount of calculation resources, similarly to the first variation. Moreover, in the second variation, the sensors are clustered based on the consecutive abnormal times, and therefore clustering is performed with consideration given to fluctuations in normal/abnormal determination results. For this reasons, with the second variation, more accurate sensor groups are presented.

Third Variation

In a third variation, the analysis model acquired by the analysis model acquisition unit 12 is different from that of the first embodiment described above. Also, the processing performed by the history information generation unit 14 and the clustering unit 15 is therefore also different.

In the third variation, the analysis model acquisition unit 12 acquires a set of one or more correlation models as analysis models. The correlation models are configured to be able to estimate a given sensor value when sensor values of one or more predetermined sensors are input. The correlation models include a regression equation for estimating a specific sensor value with use of one or more sensor values of other data items, and an allowable range of estimation error.

By applying the correlation models to the collected state information, the abnormality determination unit 13 determines a normal or abnormal state for each sensor, that is to say for each correlation model, and outputs the determination results.

In the third variation, the history information generation unit 14 specifies the length of time for which it was consecutively output that a correlation model is abnormal, and uses the specified length of time as the history information. The history information includes lengths of time for which it was consecutively determined that a correlation model is abnormal, with use of the most recent time in a predetermined period as the end point. Specifically, the history information includes the identifiers of correlation models, the data items included in the correlation models, and the length of time for which it was consecutively determined that a correlation model is abnormal using the most recent time in the predetermined period as the end time (hereinafter, called the “consecutive correlation model abnormal time”).

Also, the history information generation unit 14 can calculate the length of the consecutive correlation model abnormal time using statistical processing. This is for the case where the sensor data fluctuates due to sensor noise or disturbance so that the abnormality level becomes low and the normal/abnormal determination fluctuates between normal and abnormal. Furthermore, the history information generation unit 14 may acquire the information necessary for generating the history information from the analysis model acquisition unit 12 and the abnormality determination unit 13.

Specifically, first, the history information generation unit 14 divides the predetermined period into multiple periods, and for each divided period, determines whether or not the percentage of time of abnormal determination results is greater than a predetermined threshold value. The history information generation unit 14 then specifies a group of divided periods having consecutive abnormal determination results using the most recent time in the predetermined period as the end point, and uses the length of the specified group of divided periods as the length of the consecutive correlation model abnormal time. Note that the overlapping of normal or abnormal determination results for each sensor in the predetermined period may be permitted or prohibited.

Also, the predetermined threshold value used in the determination in divided periods may be set by the user giving a desired numerical value, or may be set based on a confidence interval in a Poisson distribution in the length of the divided periods when it is supposed that the normal/abnormal fluctuations are random.

In the third variation, the clustering unit 15 clusters the sensors into one or more groups based on time series data regarding the abnormal or normal state of all of the correlation models included in the analysis model in the predetermined period.

Specifically, first, the clustering unit 15 clusters the correlation models included in the analysis model into one or more groups based on time series data regarding the abnormal or normal state of all of the correlation models included in the analysis model in the predetermined period. The clustering unit 15 then clusters the sensors based on the results of clustering the correlation models.

For example, for each sensor, the clustering unit 15 counts the number of times that the sensor is included in and appears in a correlation model in each cluster, and assigns the sensor to the cluster for which the appearance count is the highest. At this time, if there are multiple clusters with the same appearance count, the sensor may be assigned to both of the clusters with the same appearance count, or may be assigned to one of the clusters based on a predetermined rule.

Also, in the third variation, the clustering unit 15 can cluster the correlation models with use of a clustering algorithm used in data mining, such as k-means, x-means, NMF, Convolutive-NMF, affinity propagation, or the like.

In another example, assume that the time series data regarding the abnormal or normal state of all of the correlation models in the predetermined period includes one-dimensional feature amounts (e.g., continuous abnormal time) with respect to time. In this case, the clustering unit 15 can also use a change-point detection or time-series segmentation algorithm used in data mining in addition to the clustering algorithm used in data mining.

Program

It is sufficient that the program of the first embodiment is a program for causing a computer to execute steps S1 to S5 shown in FIG. 6. By this program being installed in the computer and executed, it is possible to realize the system analyzing device 100 and the system analyzing method of the present embodiment. In this case, a CPU (Central Processing Unit) of the computer functions and performs processing as the state information collection unit 11, the analysis model acquisition unit 12, the abnormality determination unit 13, the history information generation unit 14, the clustering unit 15, and the output unit 16.

Also, the program of the first embodiment may be executed by a computer system constructed by multiple computers. For example, in this case, the computers may each function as any one of the state information collection unit 11, the analysis model acquisition unit 12, the abnormality determination unit 13, the history information generation unit 14, the clustering unit 15, and the output unit 16.

Furthermore, the program of the first embodiment may be stored in a storage device of a computer that realizes the system analyzing device 100, and read out and executed by the CPU of the computer. In this case, the program may be provided as a computer-readable recording medium, or may be provided via a network.

### Second Embodiment

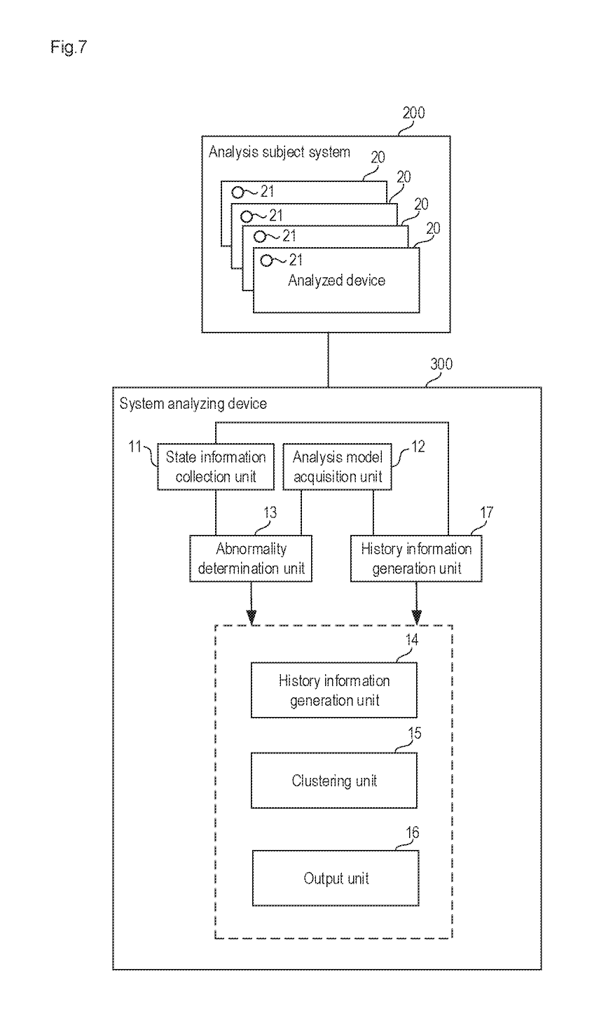

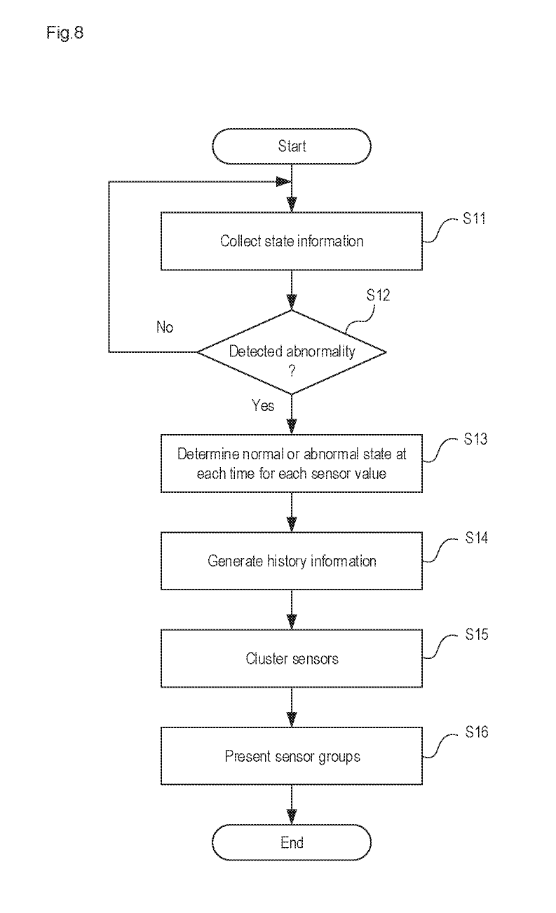

Next, a system analyzing device, a system analyzing method, and a program according to a second embodiment of the present invention will be described with reference to FIGS. 7 and 8.

Device Configuration

First, the schematic configuration of the system analyzing device according to the second embodiment of the present invention will be described with reference to FIG. 7. FIG. 7 is a block diagram showing the specific configuration of the system analyzing device according to the second embodiment of the present invention.

As shown in FIG. 7, a system analyzing device 300 of the second embodiment includes an abnormality detection unit 17, unlike the system analyzing device 100 of the first embodiment shown in FIGS. 1 and 2. Other aspects of the system analyzing device 300 have the same configurations as in the system analyzing device 100. The following description focuses on differences from the first embodiment.

The abnormality detection unit 17 detects an abnormal state of the analysis subject system 200, the analyzed device 20, or a sensor based on state information collected by the state information collection unit 11. Specifically, the abnormality detection unit 17 checks the sensor values included in the state information against a predetermined abnormality detection condition, and determines that an abnormality has occurred in a sensor if the sensor values satisfy the abnormality detection condition.

Also, in the second embodiment, the abnormality detection condition is set with use of a sensor value from a specific sensor, the amount of sensor value increase/decrease, or the like, or a combination thereof. Also, the abnormality detection condition may be an abnormal detection condition that has been set in the analysis model.

In the second embodiment, for each sensor, the history information generation unit 14 generates history information with respect to a past predetermined period that has, as a reference, the time point at which abnormality was detected by the abnormality detection unit 17. The length of the predetermined period may be designated by the user as desired. Also, the starting point of the predetermined period may be the earliest time in the period in which the abnormality occurred in the analysis performed with use of the analysis model, or may be the time point at which the immediately previous instance of clustering was performed.

Device Operation

Next, operations of the system analyzing device 300 in the second embodiment of the present invention will be described with reference to FIG. 8. FIG. 8 is a flowchart of operations of the system analyzing device 300 according to the second embodiment of the present invention. FIG. 7 will be referenced as necessary in the following description. Also, in the second embodiment, a system analyzing method is implemented by causing the system analyzing device 300 to operate. Accordingly, the following description of operations of the system analyzing device 300 will substitute for a description of the system analyzing method in the second embodiment.

First, it is assumed that the analysis model acquisition unit 12 has acquired an analysis model in advance. As shown in FIG. 8, first, the state information collection unit 11 collects state information in a predetermined period from the analysis subject system 200 (step S11).

Next, based on the state information collected in step S11, the abnormality detection unit 17 executes abnormality detection and determines whether or not an abnormality was detected (step S12). If the result of the determination in step S12 is that an abnormality was not detected, step S11 is executed again after a predetermined period has elapsed.

On the other hand, if the result of the determination in step S12 is that an abnormality was detected, the abnormality determination unit 13 applies the analysis model acquired in advance by the analysis model acquisition unit 12 to the state information, and, for each sensor, determines a normal or abnormal state at each time (step S13).

Next, with respect to a past predetermined period that has, as a reference, the time point at which the abnormality was detected in step S12, the history information generation unit 14 generates history information based on the normal/abnormal determination results of each of the sensors obtained by the abnormality determination unit 13 (step S14).

Next, based on the history information generated in step S14, the clustering unit 15 clusters the sensors included in the analysis model into one or more groups (step S15).

Next, the output unit 16 presents the sensor groups obtained by the clustering in step S15 to the user such as the operator or the system (step S16). The above-described processing in the system analyzing device 300 thus ends. Also, steps S1 to S16 are executed again when state information is output from the analysis subject system 200 after a predetermined period has elapsed.

### Effects of Second Embodiment

As described above, in the second embodiment, similarly to the system analyzing device 100 of the first embodiment, even if multiple types of abnormalities are included, the system analyzing device 300 can separate the abnormalities according to type by performing clustering. Effects similar to those of the first embodiment can be obtained in the second embodiment as well. Furthermore, in the second embodiment, abnormality detection is performed, and therefore the period of generation of the history information is set automatically. For this reason, the burden during operation of the system by the operator is alleviated.

Program

It is sufficient that the program of the second embodiment is a program for causing a computer to execute steps S11 to S16 shown in FIG. 8. By this program being installed in the computer and executed, it is possible to realize the system analyzing device 300 and the system analyzing method of the present embodiment. In this case, a CPU (Central Processing Unit) of the computer functions and performs processing as the state information collection unit 11, the analysis model acquisition unit 12, the abnormality determination unit 13, the history information generation unit 14, the clustering unit 15, the output unit 16, and the abnormality detection unit 17.

Also, the program of the second embodiment may be executed by a computer system constructed by multiple computers. For example, in this case, the computers may each function as any one of the state information collection unit 11, the analysis model acquisition unit 12, the abnormality determination unit 13, the history information generation unit 14, the clustering unit 15, the output unit 16, and the abnormality detection unit 17.

Furthermore, the program of the second embodiment may be stored in a storage device of a computer that realizes the system analyzing device 300, and read out and executed by the CPU of the computer. In this case, the program may be provided as a computer-readable recording medium, or may be provided via a network.

Although the above first and second embodiments describe cases where the analysis subject system 200 is a power generating plant system, the analysis subject system 200 is not limited to this in the present invention. Examples of the analysis subject system include an IT (Information Technology) system, a plant system, a structure, and a transportation device. In these cases as well, the system analyzing device can cluster data items that are types of data included in information that indicates the state of the analysis subject system.

Furthermore, although the above first and second embodiments focus on examples in which the function blocks of the system analyzing device are realized by a CPU executing a computer program stored in a storage device or a ROM, there is no limitation to this in the present invention. In the system analyzing device of the present invention, all of the function blocks may be realized by dedicated hardware, and a configuration is possible in which part of the function blocks are realized by hardware, and the remaining function blocks are realized by software.

Also, in the above first and second embodiments, the system analyzing device may output, to the output device, a screen for allowing the user to, using an input device, adjust a threshold value with respect to goodness of fit to an autoregression model, and select whether or not the analysis model acquisition unit is to use autoregression information.

Also, in the present invention, the above first and second embodiments may be implemented in appropriate combinations. Furthermore, the present invention is not limited to the embodiments described above, and can be implemented in various aspects.

Physical Configuration

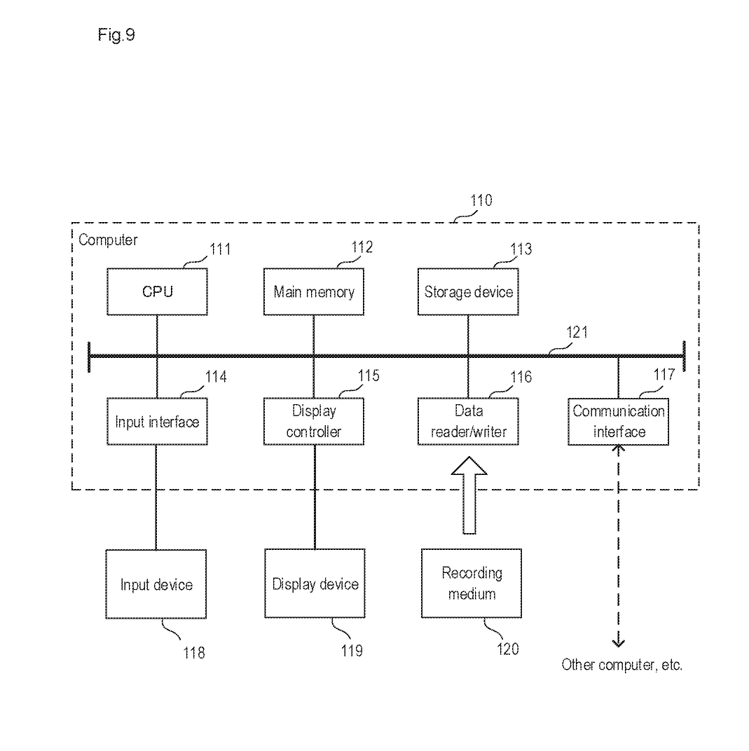

Hereinafter, a computer that realizes a system analyzing device by executing the program of the first or second embodiment will be described with reference to FIG. 9. FIG. 9 is a block diagram showing an example of a computer that realizes a system analyzing device according to the first or second embodiment of the present invention.

As shown in FIG. 9, a computer 110 includes a CPU 111, a main memory 112, a storage device 113, an input interface 114, a display controller 115, a data reader/writer 116, and a communication interface 117. These elements are connected via a bus 121 so as to be able to perform data communication with each other.

The CPU 111 deploys programs (code) of the first or second embodiment, which are stored in the storage device 113, to the main memory 112, and carries out various types of arithmetic operations by executing the programs in a predetermined sequence. The main memory 112 is typically a volatile storage device such as a DRAM (Dynamic Random Access Memory). Also, the program of the first or second embodiment is provided in a state of being stored on a computer-readable recording medium 120. Note that the program of the present embodiment may be distributed over the Internet, which is accessed via the communication interface 117.

Specific examples of the storage device 113 include a hard disk drive, as well as a semiconductor storage device such as a flash memory. The input interface 114 mediates the transfer of data between the CPU 111 and an input device 118 such as a keyboard or a mouse. The display controller 115 is connected to a display device 119 and controls the display of screens by the display device 119.

The data reader/writer 116 mediates the transfer of data between the CPU 11l and the recording medium 120, reads out a program from the recording medium 120, and writes processing results obtained by the computer 110 to the recording medium 120. The communication interface 117 mediates the transfer of data between the CPU 111 and another computer.

Also, specific examples of the recording medium 120 include a general-purpose semiconductor storage device such as a CF (Compact Flash (registered trademark)) card or an SD (Secure Digital) card, a magnetic storage medium such as a flexible disk, and an optical storage medium such as a CD-ROM (Compact Disk Read Only Memory).

Part or all of the embodiments described above can be realized by Supplementary Notes 1 to 18 described below, but the present invention is not limited to the following descriptions.

Supplementary Note 1

A system analyzing device including:

a history information generation unit that generates history information for each of a plurality of sensors included in a subject system based on sensor values output by the sensors; and

an output unit that presents, to a user, cluster information obtained by clustering the plurality of sensors into one or more groups based on the generated history information.

Supplementary Note 2

The system analyzing device according to Supplementary Note 1, further including:

a clustering unit that clusters the plurality of sensors into the one or more groups based on the generated history information.

Supplementary Note 3

The system analyzing device according to Supplementary Note 1 or 2,

wherein the history information generation unit specifies, for each of the sensors, a length of time for which it was determined that the sensor is abnormal, and uses the specified lengths of time as the history information.

Supplementary Note 4

The system analyzing device according to Supplementary Note 1 or 2,

wherein the history information generation unit specifies, for each of the sensors, a length of time for which it was consecutively determined that the sensor is abnormal, and uses the specified lengths of time as the history information.

Supplementary Note 5

The system analyzing device according to Supplementary Note 1 or 2,

wherein the history information generation unit generates the history information for each of the sensors with respect to a past period that has, as a reference, a time point at which abnormality of the sensor was detected.

Supplementary Note 6

The system analyzing device according to Supplementary Note 4, further including:

an abnormality determination unit that determines whether or not the sensors are abnormal with use of correlation models that are respectively prepared for each of the sensors and are for determining whether a corresponding sensor is normal or abnormal in accordance with the sensor value of the sensor,

wherein the history information generation unit specifies lengths of time for which it was consecutively output that the correlation models are abnormal, and uses the specified lengths of time as the history information.

Supplementary Note 7

A system analyzing method including:

(a) a step of generating history information for each of a plurality of sensors included in a subject system based on sensor values output by the sensors; and

(b) a step of presenting, to a user, cluster information obtained by clustering the plurality of sensors into one or more groups based on the generated history information.

Supplementary Note 8

The system analyzing method according to Supplementary Note 7, further including:

(c) a step of clustering the plurality of sensors into the one or more groups based on the generated history information.

Supplementary Note 9

The system analyzing method according to Supplementary Note 7 or 8,

wherein in the step (a), for each of the sensors, a length of time for which it was determined that the sensor is abnormal is specified, and the specified lengths of time are used as the history information.

Supplementary Note 10

The system analyzing method according to Supplementary Note 7 or 8,

wherein in the step (a), for each of the sensors, a length of time for which it was consecutively determined that the sensor is abnormal is specified, and the specified lengths of time as are used as the history information.

Supplementary Note 11

The system analyzing method according to Supplementary Note 7 or 8,

wherein in the step (a), the history information is generated for each of the sensors with respect to a past period that has, as a reference, a time point at which abnormality of the sensor was detected.

Supplementary Note 12

The system analyzing method according to Supplementary Note 10, further including:

(d) a step of determining whether or not the sensors are abnormal with use of correlation models that are respectively prepared for each of the sensors and output whether a corresponding sensor is normal or abnormal in accordance with the sensor value of the sensor,

wherein in the step (a), lengths of time for which it was consecutively output that the correlation models are abnormal are specified, and the specified lengths of time are used as the history information.

Supplementary Note 13

A computer-readable recording medium having a recording thereon a program that includes instructions for causing a computer to execute:

(a) a step of generating history information for each of a plurality of sensors included in a subject system based on sensor values output by the sensors; and

(b) a step of presenting, to a user, cluster information obtained by clustering the plurality of sensors into one or more groups based on the generated history information.

Supplementary Note 14

The computer-readable recording medium according to Supplementary Note 13, further causing the computer to execute:

(c) a step of clustering the plurality of sensors into the one or more groups based on the generated history information.

Supplementary Note 15

The computer-readable recording medium according to Supplementary Note 13 or 14,

wherein in the step (a), for each of the sensors, a length of time for which it was determined that the sensor is abnormal is specified, and the specified lengths of time are used as the history information.

Supplementary Note 16

The computer-readable recording medium according to Supplementary Note 13 or 14,

wherein in the step (a), for each of the sensors, a length of time for which it was consecutively determined that the sensor is abnormal is specified, and the specified lengths of time as are used as the history information.

Supplementary Note 17

The computer-readable recording medium according to Supplementary Note 13 or 14,

wherein in the step (a), the history information is generated for each of the sensors with respect to a past period that has, as a reference, a time point at which abnormality of the sensor was detected.

Supplementary Note 18

The computer-readable recording medium according to Supplementary Note 16, further causing the computer to execute:

(d) a step of determining whether or not the sensors are abnormal with use of correlation models that are respectively prepared for each of the sensors and output whether a corresponding sensor is normal or abnormal in accordance with the sensor value of the sensor,

wherein in the step (a), lengths of time for which it was consecutively output that the correlation models are abnormal are specified, and the specified lengths of time are used as the history information.

Although the present invention has been described with reference to embodiments above, the present invention is not limited to the above embodiments. Various modifications understandable to a person skilled in the art can be made to the configuration and details of the present invention within the scope of the present invention.

This application claims priority based on Japanese Application No. 2016-038078 filed on Feb. 29, 2016, and the entire contents thereof are hereby incorporated herein.

### INDUSTRIAL APPLICABILITY

As described above, according to the present invention, if multiple types of abnormalities occur in a system subjected to analysis, it is possible to separate the abnormalities according to type and output information that corresponds to respective types. The present invention can be favorably applied to system abnormality diagnosis.

### LIST OF REFERENCE SIGNS

11 State information collection unit
12 Analysis model acquisition unit
13 Abnormality determination unit
14 History information generation unit
15 Clustering unit
16 Output unit
17 Abnormality detection unit
20 Analyzed device
100 System analyzing device (first embodiment)
110 Computer
111 CPU
112 Main memory
113 Storage device
114 Input interface
115 Display controller
116 Data reader/writer
117 Communication interface
118 Input device
119 Display device
120 Recording medium
121 Bus
200 Analysis subject system
300 System analyzing device (second embodiment)

1. A system analyzing device comprising:
a history information generation unit that generates history information for each of a plurality of sensors included in a subject system based on sensor values output by the sensors; and
an output unit that presents, to a user, cluster information obtained by clustering the plurality of sensors into one or more groups based on the generated history information.

2. The system analyzing device according to claim 1, further comprising:
a clustering unit that clusters the plurality of sensors into the one or more groups based on the generated history information.

3. The system analyzing device according to claim 1,
wherein the history information generation unit specifies, for each of the sensors, a length of time for which it was determined that the sensor is abnormal, and uses the specified lengths of time as the history information.

4. The system analyzing device according to claim 1,
wherein the history information generation unit specifies, for each of the sensors, a length of time for which it was consecutively determined that the sensor is abnormal, and uses the specified lengths of time as the history information.

5. The system analyzing device according to claim 1,
wherein the history information generation unit generates the history information for each of the sensors with respect to a past period that has, as a reference, a time point at which abnormality of the sensor was detected.

6. The system analyzing device according to claim 4, further comprising:
an abnormality determination unit that determines whether or not the sensors are abnormal with use of correlation models that are respectively prepared for each of the sensors and are for determining whether a corresponding sensor is normal or abnormal in accordance with the sensor value of the sensor,
wherein the history information generation unit specifies lengths of time for which it was consecutively output that the correlation models are abnormal, and uses the specified lengths of time as the history information.

7. A system analyzing method comprising:
(a) a step of generating history information for each of a plurality of sensors included in a subject system based on sensor values output by the sensors; and
(b) a step of presenting, to a user, cluster information obtained by clustering the plurality of sensors into one or more groups based on the generated history information.

8. The system analyzing method according to claim 7, further comprising:
(c) a step of clustering the plurality of sensors into the one or more groups based on the generated history information.

9. The system analyzing method according to claim 7,
wherein in the step (a), for each of the sensors, a length of time for which it was determined that the sensor is abnormal is specified, and the specified lengths of time are used as the history information.

10. The system analyzing method according to claim 7,
wherein in the step (a), for each of the sensors, a length of time for which it was consecutively determined that the sensor is abnormal is specified, and the specified lengths of time as are used as the history information.

11. The system analyzing method according to claim 7,
wherein in the step (a), the history information is generated for each of the sensors with respect to a past period that has, as a reference, a time point at which abnormality of the sensor was detected.

12. The system analyzing method according to claim 10, further comprising:
(d) a step of determining whether or not the sensors are abnormal with use of correlation models that are respectively prepared for each of the sensors and are for determining whether a corresponding sensor is normal or abnormal in accordance with the sensor value of the sensor,
wherein in the step (a), lengths of time for which it was consecutively output that the correlation models are abnormal are specified, and the specified lengths of time are used as the history information.

13. A non-transitory computer-readable recording medium having a recording thereon a program that includes instructions for causing a computer to execute:
(a) a step of generating history information for each of a plurality of sensors included in a subject system based on sensor values output by the sensors; and
(b) a step of presenting, to a user, cluster information obtained by clustering the plurality of sensors into one or more groups based on the generated history information.

14. The non-transitory computer-readable recording medium according to claim 13, wherein the program further includes instructions for causing the computer to execute:
(c) a step of clustering the plurality of sensors into the one or more groups based on the generated history information.

15. The non-transitory computer-readable recording medium according to claim 13,
wherein in the step (a), for each of the sensors, a length of time for which it was determined that the sensor is abnormal is specified, and the specified lengths of time are used as the history information.

16. The non-transitory computer-readable recording medium according to claim 13,
wherein in the step (a), for each of the sensors, a length of time for which it was consecutively determined that the sensor is abnormal is specified, and the specified lengths of time as are used as the history information.

17. The non-transitory computer-readable recording medium according to claim 13,
wherein in the step (a), the history information is generated for each of the sensors with respect to a past period that has, as a reference, a time point at which abnormality of the sensor was detected.

18. The non-transitory computer-readable recording medium according to claim 16, wherein the program further includes instructions for causing the computer to execute:
(d) a step of determining whether or not the sensors are abnormal with use of correlation models that are respectively prepared for each of the sensors and are for determining whether a corresponding sensor is normal or abnormal in accordance with the sensor value of the sensor,
wherein in the step (a), lengths of time for which it was consecutively output that the correlation models are abnormal are specified, and the specified lengths of time are used as the history information
